(19) United States
(12) Patent Application Publication
(10) Pub. No.: US 2006/0229389 A1
(43) Pub. Date: Oct. 12, 2006

(54) EXTENDED LIFE SLURRY SEAL COMPOSITION

(76) Inventors: John Howe, Stokesdale, NC (US); Clinton L. Hairston, Martinsville, VA (US); H. Gelnn Hall III, High Point, NC (US); Frederick L. Koerwitz, Concord, NC (US)

Correspondence Address: Jacobs Patent Office, P.O. Box 390438, Cambridge, MA, 02139, US

(21) Appl. No.: 11/102,132

(22) Filed: Apr. 8, 2005

(51) Int. Cl. C08L 95/00

(52) U.S. Cl. 524/59

(57) ABSTRACT

Extended life slurry seal compositions with controllable mixing times are prepared by incorporating into a conventional water-asphalt emulsion-aggregate rock system, a slurry life-extending mixture of (i) a polycarboxylate compound aqueous solution, (ii) a polyhydroxy phenolic compound aqueous solution, wherein the phenolic compound is preferably a tannin, tannin derivative, lignin, or lignin derivative, and (iii) a non-aqueous diluent to prevent destabilizing interaction between the polycarboxylate and the polyhydroxy phenolic compound aqueous solution. The polyhydroxy phenolic compound in the aqueous solution may be natural or derived synthetically.

### BACKGROUND OF THE INVENTION

Slurry seal or microsurfacing compositions are applied to paved roads to form a protective coating on the road surfaces. These compositions contain the same basic elements—aggregate rock, water, and asphalt emulsion. Both slurry seal and micro-surfacing compositions may contain a latex polymer. The only difference between the compositions is that microsurfacing is by definition a quick setting mixture designed to allow traffic to run in one hour or less while with slurry seal, the mixture can be designed to be slow setting or quick setting depending on the emulsifier and additives used. The term “slurry seal” is used hereafter to refer to both of these protective coating compositions.

To prepare and use a slurry seal composition, an asphalt emulsion, aggregate rock, and water are loaded in a vehicle by a mechanism that prevents their mutual contact. The asphalt emulsion, aggregate rock and water are mixed in situ in a spreader box while the vehicle moves along the road and the mixture is spread on a road. After the asphalt emulsion, aggregate rock, and water are mixed, it is important that the composition flow easily and smoothly onto the road surface being protected and not prematurely solidify. Namely, the asphalt emulsion, aggregate rock, and water must be mixed well and the mixture must have sufficient fluidity (sometimes referred to as “miscibility of aggregates”). When the mixture is spread on a road, demulsification of the asphalt emulsion must take place as soon as possible so that the mixture can rapidly set up, i.e. have “quick hardenability.” A mixture which sets within one hour after the spreading thereof so that the pavement is open to traffic is described as having a “quick setting property.” Since the setting time significantly varies depending on the type of aggregate rock and temperature, it is important that the setting rate be controllable so that a mixture can be used under a wide range of different conditions.

The length of time between the beginning of mixing of the slurry seal components in the vehicle and the point in time when emulsion breakdown takes places causing the mix to become unusable is known as “mix time.” This can be measured on a small scale in a laboratory using small scale mixtures of the same components and is known as “hand mix time.”

Normally aggregate and water are premixed in situ on the delivery vehicle and then the asphalt emulsion is added.

Previous control of the useful life of the slurry seal mixture has relied upon large amounts of aluminum sulfate or other chemical break retarders. However, as the operating temperature increases, the addition of more aluminum sulfate or retarders causes the asphalt emulsion-water-aggregate rock mix slurry to separate into a non-homogeneous system with the emulsion and aggregate rock separated producing a “false slurry” which cannot be uniformly spread on a road surface. The false slurry results from the excess of water in the system.

Accordingly, it is an object of this invention to overcome the stability problem by forming a slurry seal composition which can remain fluid at elevated temperature with less total water than previously used. The slurry remains fluid at elevated temperature so that “hand working” around corners, for example, can easily be accomplished without separation of the aggregate rock from the emulsion even at hot ambient temperature.

### SUMMARY OF THE INVENTION

Extended life slurry seal compositions with controllable mixing times and improved segregation resistance are obtained by incorporating a slurry-life extending amount of a 3-component mixture of (i) a polycarboxylate compound in water, (ii) an aqueous solution containing a polyhydroxy phenolic compound, and (iii) a non-aqueous liquid diluent to prevent premature interaction between the polycarboxylate and the polyhydroxy phenolic compound, into a slurry seal composition comprising aggregate rock, asphalt emulsion, and water.

The 3-component mixture may be added to the water (known in the industry as “premix” water) which is mixed with the aggregate rock. Preferably, however, it is added to the water used to dissolve the emulsifier which is subsequently used to prepare the asphalt emulsion. The solution of emulsifier and water is known in the industry as the “soap.” The soap is mixed with hot asphalt in a colloid mill to make the asphalt emulsion. Additional mix time can be obtained by adding a small amount of aluminum sulfate solution to the pre-mix water before mixing with the aggregate.

### BRIEF DESCRIPTION OF THE DRAWINGS

FIG. 1 is a graph showing the results of Example 1, demonstrating the effect of increasing the polycarboxylate content of a 3-component additive composition of the present invention on hand mix times at 110° F. (43.3° C.) in the absence of any aluminum sulfate. The additive solution is added to the premix water.

FIG. 2 is a graph showing the effect of increasing amounts of the 3-component additive compositions of Examples 1-F and 2 when added to a soap solution used to prepare an asphalt emulsion before mixing with aggregate and water. No aluminum sulfate is present.

FIG. 3 is a graph showing the effect of increasing amounts of the 3-component additive compositions of Examples 1-F and 2 when added to a soap solution used to prepare an asphalt emulsion before mixing with aggregate and water. 0.5 part by weight of a 16% aluminum sulfate aqueous solution is also present.

FIG. 4 is a graph showing the effect of increasing amounts of the 3-component additive compositions of Examples 1-F and 2 when added to a soap solution used to prepare an asphalt emulsion before mixing with aggregate and water. 1 part by weight of a 16% aluminum sulfate aqueous solution is also present.

FIG. 5 is a graph showing the effect of using lignin or a lignin derivative as the polyhydroxy phenolic compound with the addition of 0 to 2% aluminum sulfate. The graph further includes comparative data of the performance of each individual component of the invention alone.

FIG. 6 is a graph showing the effect of water addition to the aggregate evaluated by the test method for Cone Consistency (ISSA #106)

### DESCRIPTION OF THE PREFERRED EMBODIMENTS

The slurry compositions of this invention broadly comprise aggregate rock, water, and an asphalt (or other bituminous product) emulsion made up of bitumen, water and an emulsifier, in combination with a slurry life-extending mixture of (i) a polycarboxylate compound, (ii) an aqueous solution containing a polyhydroxy phenolic compound, and (iii) a non-aqueous diluent to prevent premature interaction between the polycarboxylate and the polyhydroxy phenolic compound aqueous solution.

Preferably the polyhydroxy phenolic compound is selected from the group consisting of tannin, a tannin derivative, lignin, and a lignin derivative.

More particularly, the slurry seal compositions are formulated from (1) 100 parts by weight (pbw) aggregate rock which is a fine stone or mineral aggregate and/or mineral filler, (2) water, in an amount of about 3 to about 15 pbw per 100 pbw aggregate rock, to obtain flowable slurry consistency, and (3) about 10 to about 20 pbw of an asphalt emulsion (containing about 40 to 75% solids) per 100 pbw aggregate rock. Usually, densely-graded aggregates, such as granite screenings, lime-stone screenings, dolomite screenings and blast furnace slag, are combined with bituminous emulsions to produce slurry seal compositions. These aggregates range in size from anything passing all through a sieve of No. 4, and even No. 10 mesh, with from 15% to 20% passing through as fine a mesh as 200 mesh, as described in ASTM C 136.

The asphalt emulsion may be prepared in a conventional manner using one or more suitable emulsifiers. A particularly preferred class of emulsifiers are the liquid polyamines disclosed in U.S. Pat. No. 6,667,382, the subject matter of which is incorporated herein by reference. More preferably the emulsifier is a linear or branched tallow amine, such as linear or branched tallow tetramine, tallow triamine, tallow diamine, tallow monoamine, and blends thereof. Also included within the scope of this invention are ethylene oxide and propylene oxide derivatives of the tallow amines, either alone or in blends with tallow amines. Lignin amines and derivatives may be used in lieu of the tallow amines.

The asphalt used in the emulsion may be any bitumen product derived from domestic or foreign crude oil, especially one ordinarily used for the paving of a road. Examples of the asphalt include straight asphalt, semi-blown asphalt, blown asphalt, polymer-modified asphalt, tar, coal tar and the like. It also includes bitumen, petroleum oil, oil residue of paving grade, plastic residue from coal tar distillation, petroleum pitch, and asphalt cements diluted from solvents (cutback asphalts). Practically any viscosity or penetration graded asphalt cement for use in pavement construction may be used in the present invention.

The content of asphalt in the asphalt emulsion composition is preferably about 40% to about 75%, more preferably about 50 to about 70%, and most preferably about 55 to about 65% by weight based on the total weight of the asphalt emulsion composition.

To impart a high-level of durability to a road, the asphalt emulsion preferably contains a polymer or latex for modification of asphalt. Examples of the polymer for modification of asphalt include synthetic rubbers such as a styrene-butadiene rubber, a styrene-butadiene-styrene rubber, a chloroprene rubber and the like; thermoplastic resins such as an ethylene-vinyl acetate copolymer, an ethylene-ethyl acrylate copolymer and the like; and natural rubbers. Examples of the latex include a styrene-butadiene latex, a chloroprene latex, a neoprene latex and the like. The polymer/latex generally is present in an amount of about 1 to about 20, preferably about 3 to about 10,% by weight of the asphalt emulsion in the composition.

The life-extending amount of a 3-component mixture of (i) a polycarboxylate compound, (ii) an aqueous solution containing a polyhydroxy phenolic compound, and (iii) a non-aqueous liquid diluent which prevents premature interaction between the polycarboxylate and the polyhydroxy phenolic compound aqueous solution is added to either the asphalt emulsion or the aggregate rock.

While most any polycarboxylate compound may be used in the present invention, the preferred polycarboxylate compounds are copolymers prepared by copolymerizing (a) a polyalkylene glycol monoester monomer having about 5 to 300 mols of one or more oxyalkylene groups each having 2 to 3 carbon atoms, with (b) at least one monomer selected from among acrylic monomers, unsaturated dicarboxylic monomers and allylsulfonic monomers. Such polycarboxylate compounds and their methods of preparation are disclosed in U.S. Pat. No. 5,707,445, the subject matter of which is incorporated herein by reference. Additional preferred polycarboxylate compounds are copolymers prepared by copolymerizing (a) allyl alcohol having about 5 to 300 mols of one or more oxyalkylene groups each having 2 to 3 carbon atoms with (b) at least one monomer selected from acrylic acid and methacrylic acid. Such compounds are disclosed in U.S. Pat. No. 6,569,234 B2, the subject matter of which is incorporated herein by reference.

Polyhydroxy phenolic compounds are well known. Suitable polyhydroxy phenolic compounds contain acidic phenol groups. Examples of suitable compounds include such as catechol, methylene-bridged poly(alkylphenols), coumaryl alcohol, coniferyl alcohol, sinapyl alcohol, lignin and tannic acid (a.k.a. tannin). Preferably the polyhydroxy phenolic compound is tannin, a tannin derivative, lignin, or a lignin derivative.

Tannin, also known as tannic acid, is a polyhydroxy phenolic compound containing acidic phenol groups. Tannins are extracted from various plants and trees, which can be classified according to their chemical properties as (a) hydrolyzable tannins; (b) condensed tannins; and (c) mixed tannins containing both hydrolyzable and condensed tannins. Preferred tannin materials useful in the present invention are those that contain a tannin extract from naturally occurring plants and trees, and are normally referred to as vegetable tannins. Suitable vegetable tannins include the crude, ordinary or hot-water-soluble condensed, vegetable tannins. Quebracho and mimosa are preferred condensed vegetable tannins. Other vegetable tannins include mangrove, spruce, hemlock, gabien, wattles, catechu, uranday, tea, larch, myrobalan, chestnut wood, divi-divi, valonia, summac, chinchona, oak, etc. These vegetable tannins are not pure chemical compounds with known structures, but rather contain numerous components including phenolic moieties such as catechol, pyrogallol, etc., condensed into a complicated polymeric structure.

Preferably the tannin is from Quebracho, the wood and bark extract of any number of South American trees of different genera of the order Sapindales. The main components of Quebracho are aspidospermine, tannin/tannic acid, and quebrachine. The two principle grades of Quebracho include crude Quebracho and bisulfite-treated or refined Quebracho. Most preferably the bisulfite-treated version is used. The tannin is generally used as an aqueous solution containing about 3 to 25% tannin, preferably about 5-15%.

Lignin and lignin derivatives are also preferred polyhydroxy phenolic compounds for extending the life of asphalt slurries. Commercial lignin is currently produced as a co-product of the paper industry, separated from trees by a chemical pulping process. Lignosulfonates (also called lignin sulfonates and sulfite lignins) are products of sulfite pulping. Kraft lignins (also called sulfate lignins) are obtained from the kraft pulping process. Other delignification technologies use an organic solvent or high pressure steam treatments to remove lignins from plants.

The third component of the slurry life-extending mixture is a non-aqueous liquid diluent. The non-aqueous diluent is a liquid at room temperature and it reduces the rate of reaction between the polycarboxylate and the polyhydroxy phenol. Preferably the diluent liquid hydrogen bonds to either the polycarboxylate or the polyhydroxy phenol.

Suitable non-aqueous liquid diluent include (i) alcohols such as methanol, ethanol, propanol, isopropanol, and the like; (ii) glycols such as ethylene glycol, diethylene glycol, propylene glycol, dipropylene glycol, hexylene glycol, and the like; (iii) alkoxylated alcohols, i.e. ethoxylated, propoxylated or ethoxylated-propoxylated short chain alcohols which are liquids at room temperature, such as decyl alcohol plus 6 moles ethylene oxide; (iv) glycol ethers such as reaction products of ethylene glycol, diethylene glycol, or propylene glycol with methanol, ethanol, propanol and butanol; (v) polyethylene glycol polymers and polyethylene glycol ethers such as diethylene glycol monobutyl ether, diethylene glycol monoethyl ether, ethylene glycol monobutyl ether, triethyleneglycol dimethyl ether, and polyethylene glycol butyl or dimethyl ethers; and low molecular weight polyethylene glycol polymers. Preferably the non-aqueous liquid diluent is a polyethyleneglycol polymers such as PEG 200 molecular weight, PEG 300, PEG 400 and the like.

To produce the 3 component composition, an aqueous solution of the polyhydroxy phenol compound is formed. This solution can have from about 10 to 40% by weight polyhydroxy phenol, preferably about 20 to 35%. To the polyhydroxy phenol solution is added the polycarboxylate compound aqueous solution and the non-aqueous liquid diluent. The polycarboxylate aqueous solution generally will contain about 20 to 60% by weight polycarboxylate, preferably about 30 to 50%. The non-aqueous liquid diluent is generally used neat, but it can be diluted if desired.

The polycarboxylate solution and the polyhydroxy phenol solution are generally used in a weight ratio of about 1:3 to 3:1, preferably about 1:1. The non-aqueous liquid diluent is used in an amount of about 50 to 150% by weight of the polycarboxylate solution. Most preferably the three components are used in a ratio of 1:1:1.

A particular benefit of the present invention is that cohesion development is not affected when the mix-time extending mixture of the present invention is added to the system. The strength of the bond between aggregate particles glued together by bitumen is measured by determining the cohesion or force required to break a sample of the cured mix. This is directly related to the emulsifier formulation and amount of emulsion, pre-mix water, break additive, and the time the treated road surface must remain idle before traffic is allowed on it.

A second benefit of this invention is that it expands the range for pre-mix water addition to the aggregate while maintaining uniformly consistent slurry. For most systems to meet necessary mix times, especially in climates with temperatures above 38° C. (100° F.), high levels of water must be added to the aggregate. A direct result of the increased water addition is separation of the asphalt emulsion from the aggregate, flotation of fines to the surface, and flotation of the asphalt to the surface. These conditions require long setting times and produce a tacky surface that can track when the roadway is opened to traffic.

A third benefit of this invention is increased performance from a break additive, such as aluminum sulfate or an amine/amine derivative, at a reduced rate of addition. For example, the addition of aluminum sulfate will extend the mix-time of the slurry, but will become less effective at rates above 3%. This invention provides excellent dispersion of the break additive yielding extended mix properties at lower dosages. Lower dosages of a break additive, especially aluminum sulfate, are preferable as they will often cause the road surface to look gray. This invention is helpful in hot conditions and with reactive aggregates since the slurry can be “worked” or manipulated around corners by hand before curing prevents further movement of the slurry.

The result of adding increasing amounts of the mix-time extending composition to an asphalt emulsion containing Asfier N480L is to convert the quick-curing N480L emulsion into a controllable quick setting system, while maintaining the benefits of high adhesive strength obtained with N480L.

One method of extending the mix time of an asphalt slurry is by the addition of water. However, this is undesirable when carried to extreme because it may result in aggregate emulsion separation at high addition levels in high temperature conditions. The addition of the slurry life extending mixture of the present invention allows a more linear increase in mix time as the aluminum sulfate increases, without aggregate emulsion separation.

The following non-limiting examples demonstrate the present invention and its benefits. All parts and percents are by weight unless otherwise specified.

### EXAMPLE 1

A series of slurry life-extending mixtures were prepared from (i) 10 parts of Quebracho powder in 24 parts water to form a 29.4% Quebracho solution, (ii) a 40% solution of a polycarboxylate compound sold by Kao Corporation under the tradename Mighty 21ES, and (iii) PEG 200 (polyethylene glycol, 200 molecular weight). The specific compositions prepared and evaluated are shown in Table 1.

| | % | | |
|---|---|---|---|
| | Quebracho | % | |
| | solution | Polycarboxylate | % |
| Sample | (29.4% active) | (40% active) | PEG 200 |
| A | 33.3 | 5.0 | 61.7 |
| B | 33.3 | 10.0 | 56.7 |
| C | 33.3 | 15.0 | 51.7 |
| D | 33.3 | 20.0 | 46.7 |
| E | 33.3 | 25.0 | 41.7 |
| F | 33.4 | 33.3 | 33.3 |

Hand mix formulations were prepared to evaluate the 6 compositions for mixing time. 100 grams aggregate rock was added to a mixing container. 10 grams of water and 0.75 grams of a 3-component test formulation was added to the aggregate and mixed until homogeneous. 13 grams of an asphalt emulsion containing 1.5% Asfier N480L emulsifier was added to the mixture and stirring begun. Each mixture was stirred while being held in a water bath set at 110° F. (43.3° C.). The asphalt emulsion and all additives were equilibrated to 110° F. (43.3° C.) prior to the mix tests to simulate a hot day. Stirring proceeded using a metal spatula, by hand, at the rate of 1-2 revolutions per minute until the asphalt emulsion broke. The initial mixtures were all liquids with the aggregate and emulsion homogeneous.

Breaking of the emulsion was easily noted when the liquid gradually became less fluid and eventually formed a ball.

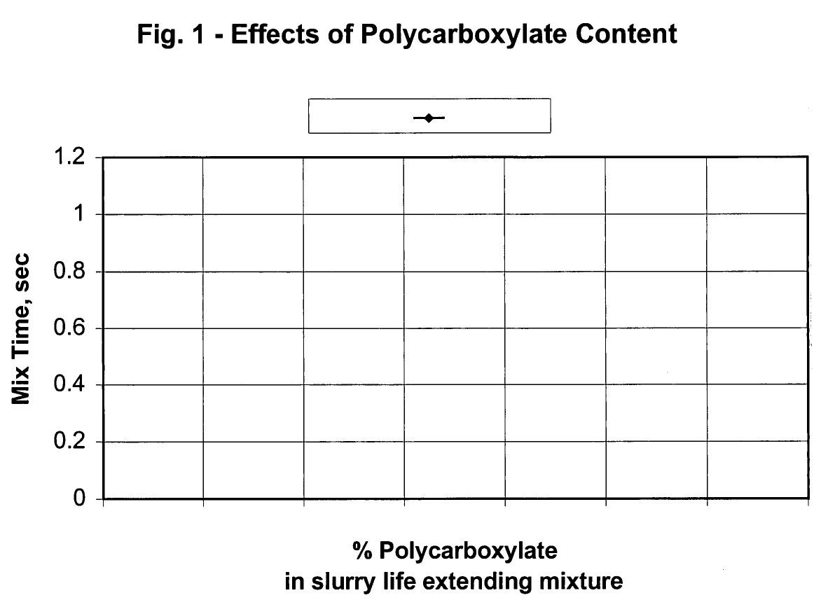

The results of these tests are shown in FIG. 1. As the amount of polycarboxylate increased for a constant amount of Quebracho solution, the hand mix time increased from about 110 seconds to 195 seconds.

### EXAMPLE 2

The optimum formulation from Example 1 was tested substituting sodium lignin sulfonate for the tannin in the Quebracho. A slurry life-extending mixtures was prepared from (i) a 29.4% solution of lignin (10 g sodium lignin sulfonate) in 24 g water, (ii) a 40% solution of a polycarboxylate compound sold by Kao Corporation under the tradename Mighty 21 ES, and (iii) PEG 200 (polyethylene glycol, 200 molecular weight). The specific formula prepared and evaluated was contained the lignin derivative solution:Mighty 21 ES:PEG 200) at a 33.4:33.3:33.3 ratio.

### COMPARATIVE EXAMPLE A

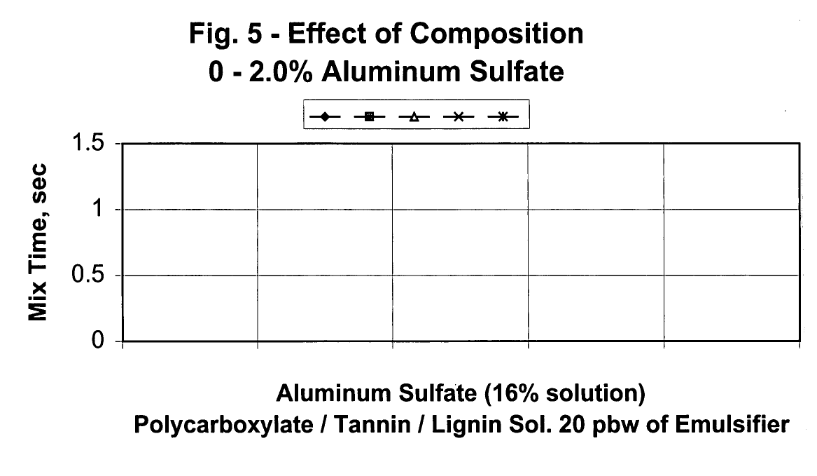

The procedure of Example 1 was repeated except that instead of the 3-component slurry life extending mixture, tannin, lignin, and the carboxylate polymer were used individually. None of the individual components alone extended the mix time. They each resulted in mix times no more than 75 seconds, irrespective of the amount of aluminum sulfate present in each system. These results are presented visually in FIG. 5 which shows that as the amount of aluminum sulfate is increased, the mixing time remains constant or decreases slightly when comparing tannin, lignin, and polycarboxylate.

### EXAMPLE 3

The tannin-containing Sample F from Example 1 and the lignin-containing sample from Example 2 were each evaluated as 3-component compositions at varying levels of aluminum sulfate between 0 and 2% and with pre-mix water maintained at 10% by weight of the aggregate.

The results shown in FIG. 5 indicate that both the polycarboxylate-tannin-containing composition and the polycarboxylate-lignin-containing composition extended the mix time to substantially the same extent (more than 300 sec) when 1.5 or 2.0% aluminum sulfate was also present. At lower levels of aluminum sulfate, the tannin-containing composition was slightly superior.

### EXAMPLE 4

The mix time extending additive system of the present invention was developed for aggregates where aluminum sulfate solution is normally used to extend mix time. As the temperature increases, more aluminum sulfate solution generally extends the mix time but at some point, the slurry (emulsion, water, aggregate mix) will tend to separate into a nonhomogeneous system with emulsion and aggregate separated. This “false slurry” which results from too much water in the system, cannot be spread on a road surface uniformly.

To determine the effect of the slurry mix-time-extending compositions in systems optionally containing aluminum sulfate, the following experiments were performed using the hand mix technique described in Example 1.

In this test, a series of asphalt emulsions were prepared with varying amounts of tannin-based Sample “F” of Example 1 and lignin-based Example 2 were added into asphalt emulsions rather than being post-added individually or in combination into the slurry composition. Then aluminum sulfate was added to further extend the mix time. The asphalt emulsions were prepared by first dissolving 1.5 parts Asfier N480L emulsifier in hot water containing 1.5 parts hydrochloric acid (31%). The pH was adjusted to 1.8-2.0 by adding hydrochloric acid, then 1 part of the test slurry life extending composition was added. Finally, 2.8 parts of an SBR latex emulsion containing 3% latex polymer solids was added. This solution, known as the “soap” was then mixed with molten asphalt in a colloid mill to form the asphalt emulsions.

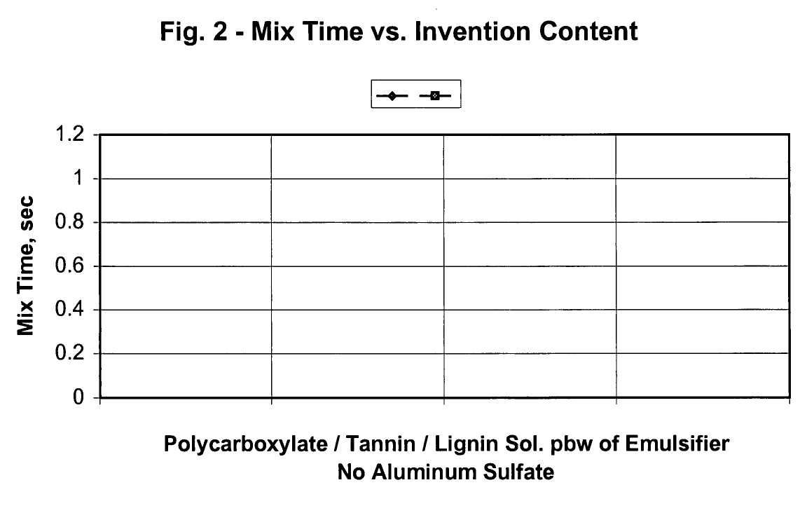

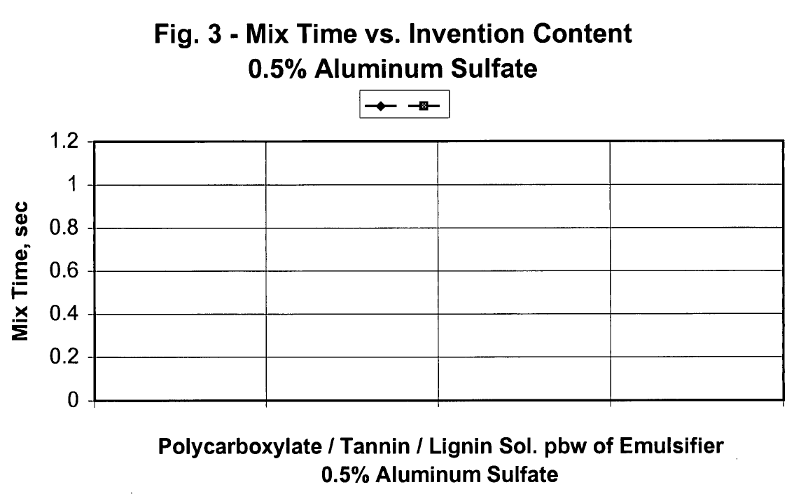

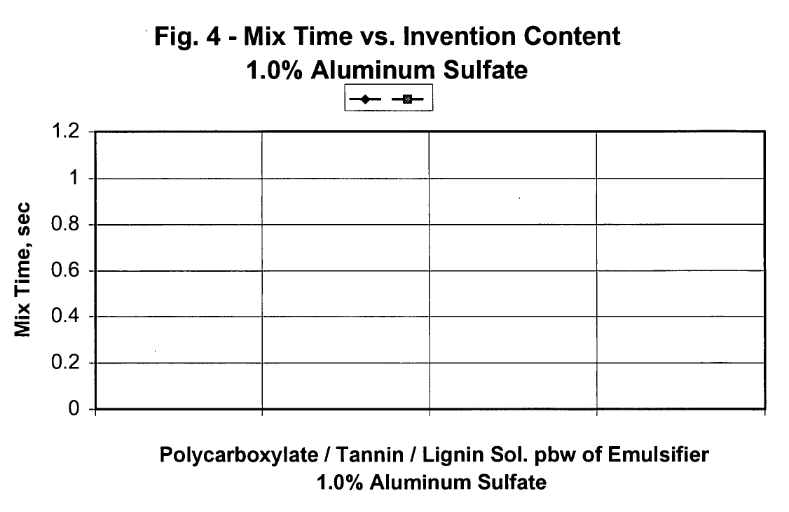

The results are shown in FIGS. 2, 3, and 4 in which the amount of a 16% aluminum sulfate solution was held constant at 0, 0.5, and 1.0% respectively. The amount of the 3-component slurry-life extending composition of the present invention is varied from 0 to 30% by weight of the emulsifier.

The results demonstrate that hand mix time improves when using conventional aluminum sulfate solution in combination with the compositions of this invention when included in the asphalt emulsion. The results indicate that less aluminum sulfate was required to achieve a 120 second minimum hand mix time when the composition of the present invention was in the asphalt emulsion. Less aluminum sulfate is preferred because it reduces the total water content of the complete system.

### EXAMPLE 5

To confirm that the present invention expands the range for pre-mix water addition while maintaining a uniformly consistent slurry and without excessive dilution a cone consistency test was performed in accordance with ISSA test method #106. The Cone Consistency Test is an industry standard which concludes that an optimum slurry is one which has a flow ranging from about 2.5-3 cm after all water has been added. Below this range, a slurry is generally too stiff to allow uniform application and adequate handworking time. Above this range, the increased water addition can cause separation of the asphalt emulsion from the aggregate, flotation of fines to the surface, and flotation of the asphalt to the surface, all of which result in long setting times and yield a tacky surface that can track when the roadway is opened to traffic.

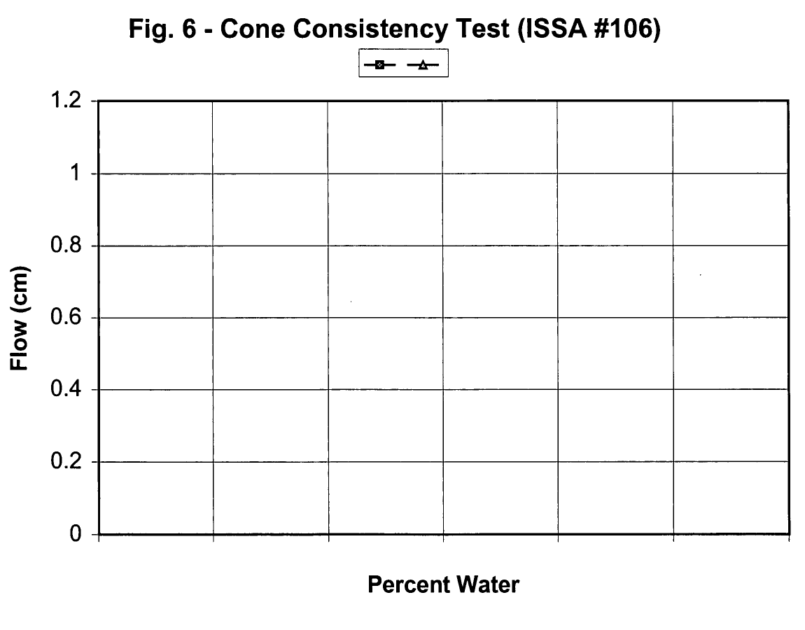

FIG. 6 shows the results of the test when using Sample F of Example 1 above as the slurry life-extender at two different levels of aluuminum sulfate. As shown in FIG. 6, this invention provides an expanded range of flow (2-4 cm), allowing for more flexibility and control of mix time without negatively affecting the slurry properties.

What is claimed is:

1. An asphalt slurry life-extending solution comprising a mixture of (i) a polycarboxylate compound aqueous solution, (ii) an aqueous solution of a polyhydroxy phenolic compound, and (iii) a non-aqueous liquid diluent in an amount sufficient to prevent a destabilizing interaction between the polycarboxylate compound and the polyhydroxy phenolic compound.

2. The solution of claim 1, wherein the polycarboxylate compound is a copolymer of (a) a polyalkylene glycol monoester monomer having about 5 to 300 mols of one or more oxyalkylene groups each having 2 to 3 carbon atoms, with (b) at least one monomer selected from the group consisting of acrylic monomers, unsaturated dicarboxylic monomers and allylsulfonic monomers.

3. The solution of claim 1, wherein the polycarboxylate compound is a copolymer of (a) allyl alcohol having about 5 to 300 mols of one or more oxyalkylene groups each having 2 to 3 carbon atoms with (b) at least one monomer selected from acrylic acid and methacrylic acid.

4. The solution of claim 1, wherein the polyhydroxy phenolic compound contains acidic phenol groups.

5. The solution of claim 4, wherein the polyhydroxy phenolic compound is selected from the group consisting of tannin, a tannin derivative, lignin, or a lignin derivative.

6. The solution of claim 1, wherein the polyhydroxy phenolic compound comprises tannin or a derivative thereof.

7. The solution of claim 6, wherein the tannin or derivative thereof is extracted from a tree.

8. The solution of claim 7, wherein the tree is Quebracho.

9. The solution of claim 6, wherein the tannin or derivative is in the form of an aqueous solution containing about 3 to 25% by weight tannin.

10. The solution of claim 1, wherein the non-aqueous liquid diluent is a liquid at room temperature and reduces the rate of reaction between the polycarboxylate compound and the polyhydroxy phenolic compound.

11. The solution of claim 10, wherein the non-aqueous liquid diluent hydrogen bonds to one of the polycarboxylate and the polyhydroxy phenolic compound.

12. The solution of claim 10, wherein the non-aqueous liquid diluent is selected from the group consisting of (i) alcohols, (ii) glycols, (iii) alkoxylated alcohols, (iv) glycol ethers, (v) polyethylene glycol polymers and (vi) polyethylene glycol ethers.

13. The solution of claim 12, wherein the non-aqueous liquid diluent is a polyethyleneglycol polymer having a molecular weight of about 200 to 400 daltons.

14. The solution of claim 1, wherein the polycarboxylate solution and the polyhydroxy phenol solution are in a weight ratio of about 1:3 to 3:1, and the non-aqueous liquid diluent is about 50 to 150% by weight of the polycarboxylate solution.

15. The solution of claim 14, wherein the weight ratio of (i) an about 25 to 35% by weight polyhydroxy phenol aqueous solution; (ii) an about 5 to 15% by weight polycarboxylate solution; and (iii) an inert liquid diluent are about 1:1:1.

16. A method of preparing the solution of claim 1, which comprises (i) forming an aqueous solution containing about 10 to 40% by weight polyhydroxy phenol; (ii) forming an aqueous solution containing about 20 to 60% polycarboxylate; (iii) blending the polyhydroxy phenol solution with the polycarboxylate solution in the presence of the non-aqueous liquid diluent.

17. A method of extending the life of an asphalt slurry seal composition containing an asphalt emulsion, aggregate rock, and water, which comprises adding thereto a life-extending amount of the composition of claim 1.

18. The method of claim 17 wherein the composition of claim 1 is added to water used to form the asphalt emulsion.

19. The method of claim 17 wherein the (i) polycarboxylate compound aqueous solution, (ii) polyhydroxy phenolic compound aqueous solution, and (iii) non-aqueous liquid diluent are individually added to the water used to form the asphalt emulsion.

20. An asphalt slurry seal mixture comprising an asphalt emulsion, aggregate rock, water, a polycarboxylate compound, a polyhydroxy phenolic compound, and an inert non-aqueous liquid diluent, wherein said polycarboxylate compound, polyhydroxy phenolic compound, and inert non-aqueous liquid diluent are present in a sufficient amount to extend the working life of the slurry seal mixture to more than 120 seconds at 110° F.

21. The mixture of claim 20, wherein the polycarboxylate compound is a copolymer of (a) a polyalkylene glycol monoester monomer having about 5 to 300 mols of one or more oxyalkylene groups each having 2 to 3 carbon atoms, with (b) at least one monomer selected from the group consisting of acrylic monomers, unsaturated dicarboxylic monomers and allylsulfonic monomers.

22. The mixture of claim 20, wherein the polycarboxylate compound is a copolymer of (a) allyl alcohol having about 5 to 300 mols of one or more oxyalkylene groups each having 2 to 3 carbon atoms with (b) at least one monomer selected from acrylic acid and methacrylic acid.

23. The mixture of claim 20, wherein the polyhydroxy phenolic compound contains acidic phenol groups.

24. The mixture of claim 20, wherein the polyhydroxy phenolic compound is selected from the group consisting of tannin, a tannin derivative, lignin, or a lignin derivative.

25. The mixture of claim 24, wherein the tannin is a vegetable tannin extracted from a tree.

26. The mixture of claim 24, wherein the tree is Quebracho.

27. The mixture of claim 24, wherein the tannin or derivative is in the form of an aqueous solution containing about 3 to 25% by weight tannin.

28. The mixture of claim 20, wherein the non-aqueous liquid diluent is a liquid at room temperature and reduces the rate of reaction between the polycarboxylate and the polyhydroxy phenolic compound.

29. The mixture of claim 28, wherein the non-aqueous liquid diluent hydrogen bonds to one of the polycarboxylate and the polyhydroxy phenolic compound.

30. The mixture of claim 20, wherein the non-aqueous liquid diluent is selected from the group consisting of (i) alcohols, (ii) glycols, (iii) alkoxylated alcohols, (iv) glycol ethers, (v) polyethylene glycol polymers and (vi) polyethylene glycol ethers.

31. The mixture of claim 30, wherein the non-aqueous liquid diluent is a polyethyleneglycol polymer having a molecular weight of about 200 to 400 daltons.

32. The mixture of claim 20, wherein the polycarboxylate solution and the polyhydroxy phenol solution are present in a weight ratio of about 1:3 to 3:1, and the non-aqueous liquid diluent is in an amount of about 50 to 150% by weight of the polycarboxylate solution.

33. The mixture of claim 32, wherein the weight ratio of (i) an about 25 to 35% by weight polyhydroxy phenol aqueous solution; (ii) an about 5 to 15% by weight polycarboxylate solution; and (iii) an inert liquid diluent is about 1:1:1.
